(19) United States
(12) Patent Application Publication
(10) Pub. No.: US 2025/0102727 A1
(43) Pub. Date: Mar. 27, 2025

(54) LOCALLY ABSORBING COVER GLASS

(71) Applicant: Applied Materials, Inc., Santa Clara, CA (US)

(72) Inventors: Evan WANG, Palo Alto, CA (US); David Alexander SELL, Santa Clara, CA (US)

(21) Appl. No.: 18/894,905

(22) Filed: Sep. 24, 2024

Related U.S. Application Data
(60) Provisional application No. 63/584,993, filed on Sep. 25, 2023.

(51) Int. Cl. F21V 8/00; G02B 1/00; G02B 5/00

(52) U.S. Cl. CPC G02B 6/0093; G02B 1/002; G02B 5/003; G02B 6/0016; G02B 6/0065

(57) ABSTRACT

The present disclosure provides a waveguide combiner. The waveguide combiner includes a substrate having a top surface. The waveguide combiner includes a plurality of structures disposed over the top surface. The waveguide combiner includes a cover glass disposed over the top surface. The cover glass including an absorption region and a transparent region. The absorption region includes an absorption material.

### CROSS-REFERENCE TO RELATED APPLICATIONS

This application claims priority to U.S. Provisional Patent Application Ser. No. 63/584,993, filed on Sep. 25, 2023, which is herein incorporated by reference in its entirety.

### BACKGROUND

### Field

Embodiments of the present disclosure generally relate to waveguide combiners for augmented, mixed, and virtual reality.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners, such as augmented reality waveguide combiners, are used to assist in overlaying images. Generated light is propagated through a waveguide combiner until the light exits the waveguide combiner and is overlaid on the ambient environment. Unfortunately, waveguide combiners incorporate both grating and non-grating regions which are visually distinct.

Accordingly, improved waveguide combiners having indistinct regions is necessitated.

### SUMMARY

The present disclosure provides a waveguide combiner. The waveguide combiner includes a substrate having a top surface. The waveguide combiner includes a plurality of structures disposed over the top surface. The waveguide combiner includes a cover glass disposed over the top surface. The cover glass including an absorption region and a transparent region. The absorption region includes an absorption material.

The present disclosure also provides a waveguide combiner. The waveguide combiner includes a substrate having a top surface. The waveguide combiner includes a plurality of structures disposed over the top surface. The plurality of structures including a first grating, a second grating, and a third grating. The waveguide combiner includes a cover glass disposed over the top surface. The cover glass including an absorption region and a transparent region. The absorption region includes an absorption material.

The present disclosure also provides methods of forming waveguide combiners. The methods include disposing a plurality of structures over a substrate, the substrate having a top surface. A cover glass is disposed over a top surface of the substrate. The cover glass includes an absorption region and a transparent region. The transparent region is disposed over each structure of the plurality of structures. The cover glass and the substrate are coupled using an edge material.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of a waveguide combiner according to embodiments described herein.

FIG. 2 is a perspective, frontal view of a cover glass according to embodiments described herein.

FIG. 3A is a perspective, frontal view of a waveguide combiner having a locally absorbing cover glass disposed over a top surface of a substrate according to embodiments described herein.

FIG. 3B is a cross sectional view of a waveguide combiner having a locally absorbing cover glass disposed over a top surface of a substrate according to embodiments described herein.

FIG. 4 is a flow diagram of a method for forming a waveguide combiner, according to certain embodiments.

FIGS. 5A-5C are schematic, cross-sectional views of a portion of a substrate during a method for forming a waveguide combiner according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to film stacks for electronic devices and to methods of forming. Film stacks described herein can have superior device performance relative to conventional technologies. Methods described herein are reproducible and can yield uniform passivation layers having reduced impedance. Further, embodiments described herein can enable streamlined material handling and integration and longer shelf life for the passivated film stacks (passivated film rolls) than conventional technologies.

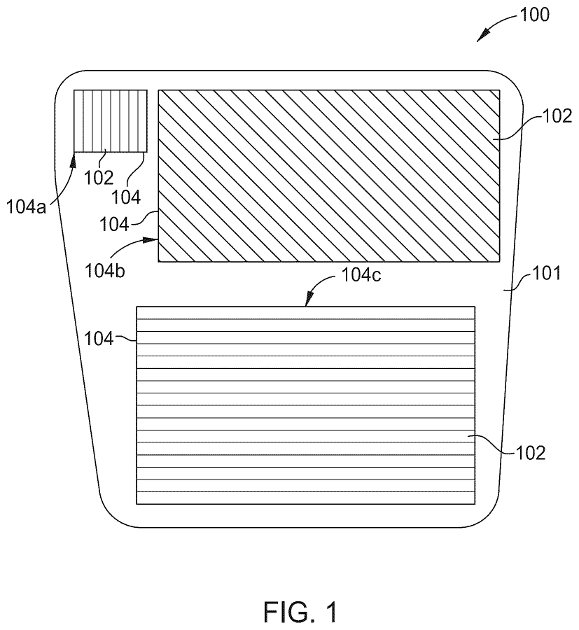

FIG. 1 illustrates a perspective, frontal view of a waveguide combiner 100. It is to be understood that the waveguide combiner 100 described below is an exemplary waveguide combiner. The waveguide combiner 100 can be an augmented reality waveguide combiner. The waveguide combiner 100 includes a plurality of device structures 102 disposed in or on a substrate 101.

The substrate 101 can be any substrate used in the art, and can be either opaque or transparent to a chosen wavelength of light, depending for the use of the substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 101 include silicon (Si), silicon monoxide (SiO), silicon dioxide (SiO₂), silicon carbide (SIC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K2O), phosphorus pentoxide (P₂O₅), calcium oxide (CaO), or combinations thereof.

The substrate 101 has a substrate transmission (T_{NG}). Substrate transmission (T_{NG}) represents the amount of light that passes through the substrate 101. The substrate 101 has a substrate reflectivity (R_{NG}). Substrate reflectivity (R_{NG}) represents the amount of light that is reflected by an exterior surface of the substrate 101. The substrate transmission and the substrate reflectivity total to a value of 1, e.g., T_{NG}+R_{NG}=1. The substrate 101 may be selected to transmit a suitable amount of light of a desired wavelength or wavelength range, e.g., T_{NG} is greater than R_{NG}. In an embodiment, a wavelength range includes one or more wavelengths from about 100 to about 3000 nanometers. In some embodiments the substrate 101 is configured such that the substrate 101 transmits greater than or equal to about 50% to about 100%, of an infrared to ultraviolet region of the light spectrum. The substrate 101 may have a refractive index greater than about 1.8. For example, the substrate can include silicon carbide, lithium niobium oxide, and glass having a refractive index of greater than 1.8.

The device structures 102 are formed from a structure material formed on and/or over the substrate 101. The structure material and the substrate 101 include a different material. The structure material includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the structure material include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof

The device structures 102 can be nanostructures having sub-micron dimensions, e.g., nano-sized dimensions, such as critical dimensions less than 1 μm. Regions of the device structures 102 can correspond to one or more gratings 104, such as a first grating 104a, a second grating 104b, and a third grating 104c. The waveguide combiner 100 includes at least the first grating 104a corresponding to an input coupling grating and the third grating 104c corresponding to an output coupling grating. The waveguide combiner can include the second grating 104b corresponding to an intermediate grating.

The device structures 102 have a structure transmission (T_{G}). Structure transmission (T_{G}) represents the amount of light that passes through the device structures 102. The device structures 102 have a structure reflectivity (R_{G}). Structure reflectivity (R_{G}) represents the amount of light that is reflected by an exterior surface of the device structures 102. The device structures 102 have at least a diffraction order (D_{G,n}), where n is any non-zero integer. Diffraction order represents the amount of light that enters an exterior surface of the device structures 102 and diffracts interior to the device structures 102. The structure transmission, the structure reflectivity, and the diffraction order total to a value of 1, e.g., T_{G}+R_{G}+D_{G,n}=1. In an embodiment, the device structure includes a first diffraction order (D_{G,+1}) and a second diffraction order (D_{G,-1}), in which T_{G}+R_{G}+D_{G,+1}+D_{G,-1}=1.

In operation of the waveguide combiner 100 a virtual image is projected from a near-eye display, such as a microdisplay, to the first grating 104a. The device structures 102 of the first grating 104a in-couple the incident beams of light of the virtual image and diffract the incident beams by the diffraction order D_{G,n} to the second grating 104b. The diffracted beams undergo total-internal-reflection (TIR) through the waveguide combiner 100 until the diffracted beams come in contact with the device structures 102 of the second grating 104b. In an embodiment, the diffracted beams may be split according to the diffraction order D_{G,n} to produce a first portion of beams, a second portion of beams, and a third portion of beams. The first portion of beams may be refracted back or lost in the waveguide combiner 100. The second portion beams may contact a structure of the device structures 102 including the second grating 104b. The third portion of beams may contact a structure of the device structures 102 including the third grating 104c. Each portion of beams, e.g., the first portion of beams, the second portion of beams, or the third portion of beams, may continue to contact structures of the device structures 102 until either the intensity of the beams refracting through the waveguide combiner 100 to the device structures 102 is depleted, or the portion of beams refracting through the device structures 102 reach the end of the second grating 104b or third grating 104c. The beams of the virtual image are propagated from the second grating 104b or the third grating 104c to overlay the virtual image over the ambient environment.

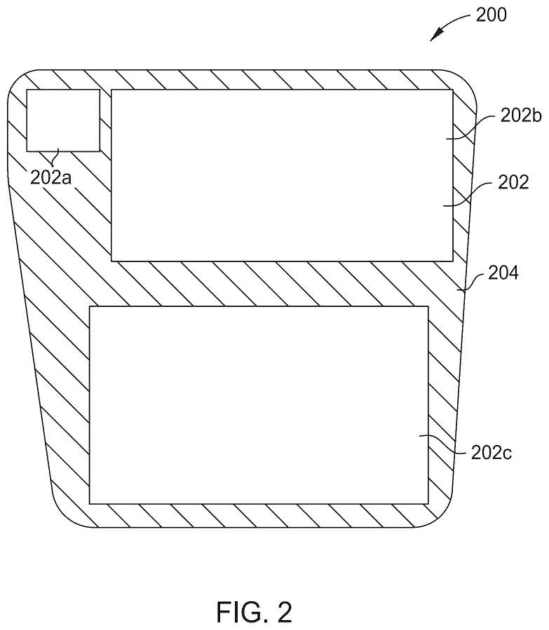

FIG. 2 illustrates a perspective, frontal view of a cover glass 200. It is to be understood that the cover glass 200 described below is an exemplary cover glass. The cover glass 200 can include any protective material that protects substrate 101. For example, the cover glass 200 can include amorphous dielectrics, non-amorphous dielectrics, crystalline dielectrics, silicon oxide, polymers, and combinations thereof. The cover glass 200 is a transparent material. In some embodiments, the cover glass 200 is transparent with an absorption coefficient smaller than 0.001. Suitable examples of a cover glass 200 may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, or combinations thereof.

The cover glass 200 includes a plurality of transparent regions 202. Each transparent region of the plurality of transparent regions is located over a corresponding device structure. Each transparent region includes a region transmission (T_{C}). Region transmission (T_{C}) represents the amount of light that passes through the transparent region of the cover glass that overlays each device structure of the plurality of device structures. In an embodiment, the cover glass 200 includes a first transparent region 202a, a second transparent region 202b, and a third transparent region 202c. The first transparent region 202a may correspond to the first grating 104a. The second transparent region 202b may correspond to the second grating 104b. The third transparent region 202c may correspond to the third grating 104c.

The cover glass 200 includes an absorbing region 204. Absorbing region 204 represents an absorption transmission (T_{A}). Absorption transmission (T_{A}) represents the amount of light that passes through the absorbing region 204 of the cover glass that does not overlay a device structure of the waveguide combiner 100. In an embodiment, the absorption transmission (T_{A}) may be less than the region transmission (T_{C}), indicating less light passes through the absorption region than the transparent region. The absorbing region 204 of the cover glass does not overlay a device structure of the waveguide combiner 100. For example, the absorbing region 204 may be oriented and/or shaped such that the absorbing region complements the waveguide grating regions, e.g., the first grating 104a, the second grating 104b, and/or the third grating 104c.

The absorbing region 204 includes an absorption material. The absorption material can include one or more types of particles, at least one of one or more dyes or one or more pigments, and a polymer matrix of one or more binders coated onto the absorbing region 204 or embedded in the absorbing region 204. In some embodiments, the absorption material includes at least one metal film. The at least one metal film may include a stack of metal films. The one or more metal films include, but are not limited to, chromium-containing films, titanium-containing films. The one or more metal films can be configured to absorb one or more wavelengths of light in the absorbing region 204. In some embodiments, the absorption material includes can include one or more filler dispersions, one or more photoinitiators, one or more epoxy resins, one or more additives, one or more silanes, one or more isocyanates, one or more acids, one or more phosphine oxides, or combinations thereof. Examples of the filler dispersions include acrylates or methacrylates. Examples of the additives include amines or amides. Example of the dyes include organic dyes. The one or more pigments include, but are not limited to, carbon black, carbon nanotubes, iron oxide black, black pigments, or combinations thereof. The one or more binders are operable to be cured by radiation, to form a polymer matrix. The one or more types of particles are disposed in the polymer matrix. The one or more binders include, but are not limited to, a UV curable binder, a LED curable binder, a thermal curable binder, an infrared curable binder, or combinations thereof.

The one or more types of particles include, but are not limited to, titanium, titanium oxide (TiO₂), chromium, Si, zirconium oxide (ZrO₂), zinc oxide (ZnO), ferrosoferric oxide (Fe₃O₄), germanium (Ge), SiC, diamond, dopants thereof, or any combination thereof. The one or more types of particles includes at least of nanoparticles or microparticles. Each nanoparticle (NP) or microparticle (MP) can be a coated particle, such as one, two, or more shells disposed around a core. In some examples, the NPs or MPs can contain one or more types of ligands coupled to the outer surface of the NPs or MPs (e.g., ligated NPs or stabilized NPs). The NPs or MPs can have one or more different shapes or geometries, such as spherical, oval, rod, cubical, wire, cylindrical, rectangular, or combinations thereof. The NPs can have a size or a diameter of about 2 nm to about 200 nm.

A particle refractive index of the one or more types of particles is greater than 2.0. In some embodiments, which can be combined with other embodiments described herein, the particle refractive index of the one or more types of particles is about 2.4 or greater. The particle refractive index greater than 2.0 provide for the absorption region having a refractive index of about 1.7 or greater. The optical density of the absorption region of about 2.0 or greater is provide by the at least one of one or more dyes or one or more pigments. The refractive index of about 1.7 or greater of the absorbing region 204 is matched to high refractive index substrates, i.e., the substrate 101 having a refractive index greater than about 1.8.

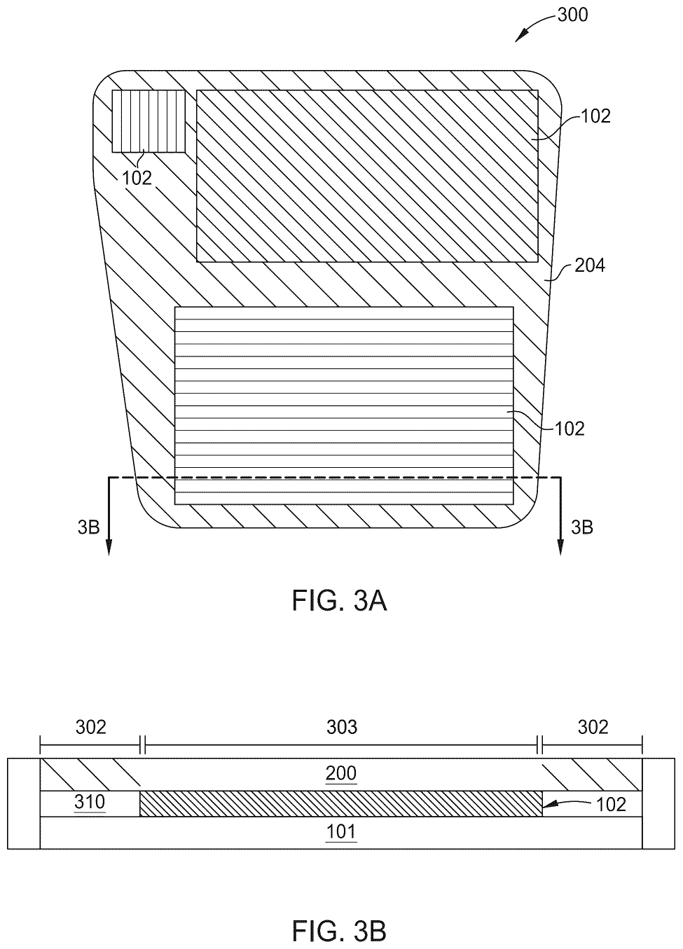

FIG. 3A illustrates a perspective, frontal view of a waveguide combiner 300 having an absorbing cover glass 200 disposed over a top surface of the substrate 101. In some embodiments, the absorbing glass 200 is disposed on the top surface of the substrate 101. The waveguide combiner 300 includes a uniform appearance due to a matching or similar transmission and reflectivity for a region of the waveguide combiner 100 that has a device structure 102 or a location that does not have a device structure 102. By overlapping the cover glass 200 with the waveguide combiner 100, device structures 102 on the waveguide combiner 100 have either the same appearance or an appearance that is within about 0.1% to about 2% error of the regions of the waveguide combiner 100 that do not have device structures 102, e.g., about 0.1% to about 1%, about 0.5% to about 1.5%, or about 1% to about 2%.

In an embodiment, the waveguide combiner 300 may achieve a uniform appearance where the substrate transmission multiplied by the absorption transmission is equal to the structure transmission multiplied by the region transmission as represented by Equation 1:

$${T}_{N G} \times {T}_{A} = {T}_{G} \times {T}_{C} \qquad Equation : 1$$

Moreover, the waveguide combiner 300 may achieve a uniform appearance where the substrate reflectivity plus the reflectivity of the absorbing region 204 (R_{A}) is equal to the structure reflectivity plus the reflectivity of the transparent region 202 (R_{C}) as represented by Equation 2:

$${R}_{N G} + {R}_{A} = {R}_{G} + {R}_{C} \qquad Equation : 2$$

Additionally, waveguide combiner 300 may achieve a uniform appearance where the absorbance of the absorbing region 204 (A_{A}) is equal to one minus the structure transmission minus the structure reflectivity as represented by Equation 3:

$${A}_{A} = 1 - {T}_{G} - {R}_{G} \qquad Equation : 3$$

FIG. 3B illustrates is a cross sectional view of a waveguide combiner 300 having a locally absorbing cover glass 200 disposed over a top surface of a substrate 101. In some embodiments, the waveguide combiner 300 may include a cover glass 200 that includes an absorption region 302 and a transparent region 303 that corresponds to a device structure 102 of the waveguide combiner 300. In some embodiments, which can be combined with other embodiments, an edge material 305. The edge material 305 can include an inner surface 306 having an adhesive material. The adhesive material can include a polymer adhesive, an epoxy, an acrylate, or a combination thereof. The inner surface 306 of the edge material 305 can be coupled to a lateral surface 307 of the substrate 101, and a lateral surface 308 of the cover glass 200.

The edge material 305 can include a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The edge material 305 can have an absorption coefficient smaller than 0.001. Suitable examples of an edge material 305 may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, or combinations thereof.

The edge material 305 can define a cavity 310. The cavity 310 can be filled with a material having a refractive index of about 1 to about 1.3, e.g., air or an aerogel material. For example, the cavity 310 can include a material of air, having a refractive index of about 1.0. As a further example, the cavity 310 can be filled with an aerogel material having a refractive index of about 1.1 to about 1.3. In some embodiments, which can be combed with other embodiments, the aerogel material can be coupled to the substrate 101 and/or the cover glass 200 via one or more adhesives disposed on a top surface of the substrate 101 or a bottom surface of the cover glass 200. The adhesive can include one or more of a polymer adhesive, an epoxy, an acrylate, or a combination thereof.

In an embodiment, the absorption region 302 and the transparent region 303 may correspond to alternating gradients of the waveguide combiner 100, in which each alternating gradient has an independent transmission or reflectivity (not shown). In some embodiments, the waveguide combiner 300 may include a cover glass 200 that includes an absorption region 302 and a transparent region 303 that corresponds to a spatially varying grating of the waveguide combiner 100 or a spatially varying region of the waveguide combiner that does not have a device structure 102. A spatially varying grating is a grating that has a transmission or reflectivity that varies within a lateral, e.g., x, y, position of the grating. In an embodiment, the waveguide combiner 100 may have a spatially varying transmission or reflectivity that varies across one or more locations of the waveguide combiner 100. In an embodiment, the waveguide combiner 300 may include a uniform transmission or reflectivity when including one or more cover glasses 200 or waveguide combiners 100 that overlap.

For example, the transmission of the waveguide combiner 300 may be represented by the transmission of the nth sheet, e.g., either a cover glass 200 or a waveguide combiner 100, as a function of the x, y position, e.g., Tₙ(x,y), where n is a non-zero integer. The transmission of the waveguide combiner 300 may then be determined by taking the product of each transmission of all of the sheets, represented by Equation 4:

$${\prod }_{n} {T}_{n} ( x , y ) = T for all x , y \qquad Equation : 4$$

Alternatively, the reflectivity of the waveguide combiner 300 may be represented by the reflectivity of the nth sheet, e.g., either a cover glass 200 or a waveguide combiner 100, as a function of the x, y position, e.g., Rₙ(x,y), where n is a non-zero integer. The reflectivity of the waveguide combiner 300 may then be determined by taking the sum of each reflectivity of all of the sheets, represented by Equation 5:

$${\sum }_{n} {R}_{n} ( x , y ) = R for all x , y \qquad Equation : 5$$

In an embodiment, constant values of the transmission, T, and the reflectivity, R, may exist where there is a uniformity across position x, y for each sheet of the n number of sheets. Alternatively, where the is not uniformity across position x, y for each sheet of the n number of sheets, the cover glass 200 may exclude regions. For example, where there is a location of the waveguide combiner 100 that has a transmission of 0, e.g., at an in coupler, a black edge coating, or other form of marking on the surface, the cover glass 200 may exclude these objects from the absorbing region 204.

In an embodiment, the waveguide combiner 300 may include a waveguide combiner 100 and a cover glass 200 that aligns with a wavelength (λ). The wavelength (λ) may correspond to a color shift of the transmission or reflection of the waveguide combiner 100 or the cover glass 200. The wavelength (λ) may adjust the transmission or reflection to be a visible wavelength, e.g., about 380 nm to about 700 nm, about 400 nm to about 600 nm, about 450 nm to about 700 nm, about 500 nm to about 600 nm, about 380 nm to about 500 nm, or the like. The transmission and reflectivity of the waveguide 300 may then be calculated according to equations 6 and 7.

$${\prod }_{n} {T}_{n} ( x , y , λ ) = T for all x , y , λ \qquad Equation : 6$$

$${\sum }_{n} {R}_{n} ( x , y , λ ) = R for all x , y , λ \qquad Equation : 7$$

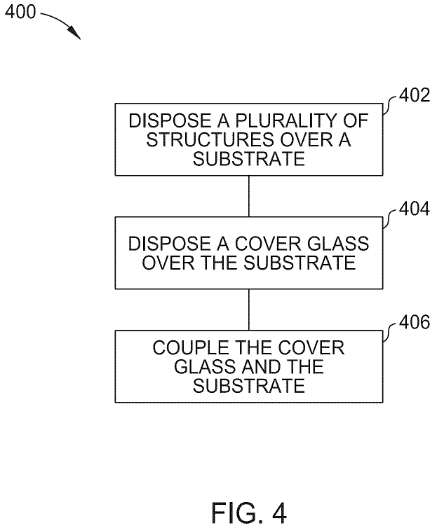

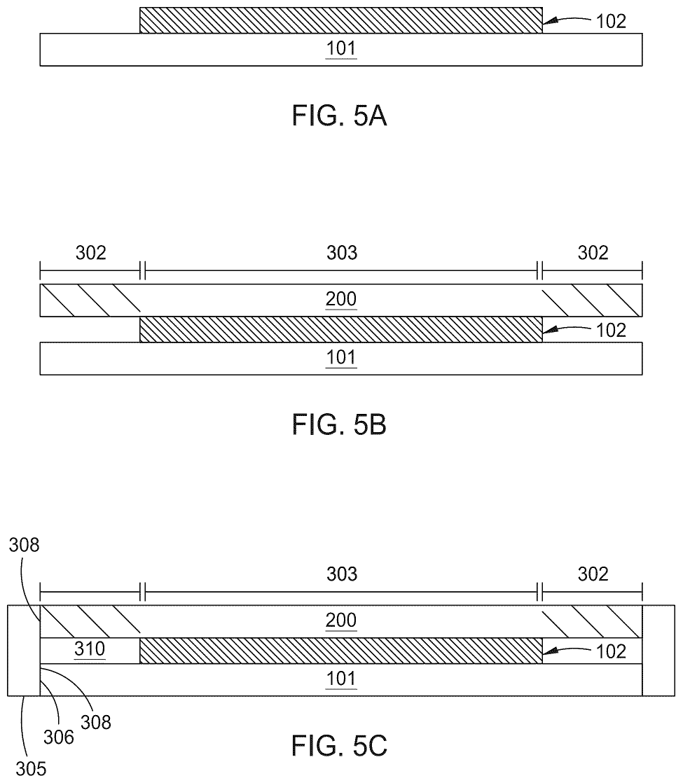

Now referring to FIG. 4, a method 400 for forming a waveguide combiner 100. FIGS. 5A-5C show a portion of a substrate 101. In one embodiment, the portion corresponds to the first grating 104a of the waveguide combiner 100 to be formed.

At operation 402, as shown in FIG. 5A, a plurality of device structures 102 are disposed on and/or over the substrate 101. The device structures 102 may be disposed on and/or over a top surface of the substrate 101. The device structures 102 may be disposed on and/or over the top surface of the substrate 101 according to one or more deposition processes. At operation 404, as shown in FIG. 5B, a cover glass 200 is disposed over the top surface of the substrate. The cover glass 200 includes an absorbing region 204 and a transparent region 202. The absorbing region 204 of the cover glass 200 is disposed over the substrate 101 such that the absorbing region 204 does not overlay a device structure of the waveguide combiner 100. The transparent region 202 is disposed over a corresponding device structure.

At operation 406, as shown in FIG. 5C, the cover glass 200 and the substrate 101 are coupled using an edge material 305. The edge material 305 includes an inner surface 306 having an adhesive material bonded thereto. The adhesive material can be configured to bond to and/or couple a lateral surface 307 of the substrate 101 and/or a lateral surface 308 of the cover glass 200.

In some embodiments, which can be combined with other embodiments, coupling the cover glass 200 and the substrate 101 further comprises forming a cavity 310 between the cover glass 200 and the substrate 101. The cavity 310 can be filled with a material having a refractive index of about 1 to about 1.3, e.g., air or an aerogel material. For example, the cavity 310 can include a material of air, having a refractive index of about 1.0. As a further example, the cavity 310 can be filled with an aerogel material having a refractive index of about 1.1 to about 1.3. In some embodiments, which can be combed with other embodiments, the aerogel material can be coupled to the substrate 101 and/or the cover glass 200 via one or more adhesives disposed on a top surface of the substrate 101 or a bottom surface of the cover glass 200. The adhesive can include one or more of a polymer adhesive, an epoxy, an acrylate, or a combination thereof.

Overall, a waveguide combiner having a cover glass that compensates a difference in transmission and reflection between a plurality of device structures, e.g., gratings, and a region of a waveguide combiner that has no device structures is presented herein. The glass cover may be overlaid such that the waveguide combiner has a uniform appearance rather than an appearance of both a region having a plurality of device structures and a region that does not have a device structure. The waveguide combiner of the present disclosure will have improved aesthetics compared to waveguide combiners that do not have a cover glass.

While the foregoing is directed to examples of the present disclosure, other and further examples of the disclosure may be devised without departing from the basic scope thereof, and the scope thereof is determined by the claims that follow.

1. A waveguide combiner, comprising:
a substrate having a top surface;
a plurality of structures disposed over the top surface; and
a cover glass disposed over the top surface, the cover glass comprising an absorption region and a transparent region, wherein the absorption region comprises an absorption material.

2. The waveguide combiner of claim 1, wherein the transparent region is disposed over each structure of the plurality of structures.

3. The waveguide combiner of claim 1, wherein the substrate has a substrate transmission (T_{NG}) and a substrate reflectivity (R_{NG}), wherein the substrate transmission (ti) is greater than the substrate reflectivity (R_{NG}).

4. The waveguide combiner of claim 3, wherein the substrate further has a structure transmission (T_{G}) and a structure reflectivity (R_{G}), and a diffraction order (D_{G,n}), wherein n is a non-zero integer.

5. The waveguide combiner of claim 4, wherein a total of the substrate transmission (T_{NG}) and the substrate reflectivity (R_{NG}) are greater than a total of the structure transmission (T_{G}) and the structure reflectivity (R_{G}).

6. The waveguide combiner of claim 4, wherein the cover glass has an absorption transmission (T_{A}) and a region transmission (T_{C}).

7. The waveguide combiner of claim 6, wherein a product of the structure transmission (T_{G}) and the absorption transmission (T_{A}) equal a product of the substrate transmission (T_{NG}) and the region transmission (T_{C}).

8. The waveguide combiner of claim 1, wherein the absorption material comprises titanium, titanium oxide (TiO₂), silicon (Si), zirconium oxide (ZrO₂), chromium, zinc oxide (ZnO), ferrosoferric oxide (Fe₃O₄), germanium (Ge), silicon carbide (SiC), diamond, dopants thereof, or any combination thereof.

9. The waveguide combiner of claim 1, wherein the absorption material comprises one or more metal films.

10. The waveguide combiner of claim 9, wherein the absorption material comprises one or more metal films.

11. The waveguide combiner of claim 1, wherein the absorption region has a refractive index of about 1.7 or greater and an optical density of about 2.0 or greater.

12. The waveguide combiner of claim 1, wherein the absorption material comprises at least one of one or more dyes or one or more pigments.

13. The waveguide combiner of claim 1, wherein the absorption material comprises a polymer matrix of one or more binders.

14. A waveguide combiner, comprising:
a substrate having a top surface;
a plurality of structures disposed over the top surface, the plurality of structures comprising a first grating, a second grating, and a third grating; and
a cover glass disposed over the top surface, the cover glass comprising an absorption region and a transparent region, wherein the absorption region comprises an absorption material.

15. The waveguide combiner of claim 14, wherein the first grating comprises a spatially varying grating.

16. The waveguide combiner of claim 14, wherein the second grating comprises a spatially varying grating.

17. The waveguide combiner of claim 14, wherein the third grating comprises a spatially varying grating.

18. A method, the method comprising:
disposing a plurality of structures over a substrate, the substrate having a top surface;
disposing a cover glass over the top surface of the substrate, wherein the cover glass comprises an absorption region and a transparent region, the transparent region disposed over each structure of the plurality of structures; and
coupling the cover glass and the substrate using an edge material.

19. The method of claim 17, further comprising disposing an aerogel material between the substrate and the cover glass.

20. The method of claim 17, wherein coupling the cover glass and the substrate further comprises disposing an adhesive material on an inner surface of the edge material and coupling the cover glass and the substrate using the adhesive material.
